(19) United States
(12) Patent Application Publication
(10) Pub. No.: US 2021/0046514 A1
(43) Pub. Date: Feb. 18, 2021

(54) SYSTEM FOR THE COLLECTION, SORTING AND PROCESSING OF MUNICIPAL WASTE

(71) Applicant: Valeriy Vitalevich DRUGOVSKOI, Moscow (RU)

(72) Inventor: Valeriy Vitalevich DRUGOVSKOI, Moscow (RU)

(21) Appl. No.: 16/966,935

(22) PCT Filed: Jan. 16, 2019
(86) PCT No.: PCT/RU2019/000020

§ 371 Date: Aug. 3, 2020

(30) Foreign Application Priority Data
Feb. 5, 2018 (RU) 2018104319

(51) Int. Cl. B07C 7/00; B09B 5/00

(52) U.S. Cl. CPC B07C 7/00; B07C 2501/0054; B09B 5/00

(57) ABSTRACT

The invention relates to the field of public utilities, namely to the collection, sorting, transportation and disposal of municipal solid waste. The system of collection, sorting and recycling of municipal waste, allowing them to implement separate collection, contains the means of transport, some collection points and waste sorting (WCSP) in the territory served by the district, processing plant wastes (WPP) in the same area, and WCSP is a indoor closed on the perimeter of the building module is equipped with an extraction window with a counter, a work table for manual sorting of waste, a cargo truck with a set of containers and bulky waste, household premises; The WPP is equipped with a fleet of crushing, pressing and other equipment for waste processing; household premises, cargo trucks and a tractor, made with the ability to move trucks between the WCSP and the WPP.

### TECHNICAL FIELD OF THE INVENTION

The invention relates to the field of public utilities, namely to the collection, sorting, transportation and disposal of municipal solid waste (MSW).

Today, the unresolved and relevance of the issues of MSW circulation in many countries of the world is great and obvious, and in the concept of sustainable development is one of the keys.

### BACKGROUND OF THE INVENTION

The known system, implemented in the method pre-treatment of consumption waste, including transportation of mixed municipal waste, unloading, fractionation and accumulation in appropriate containers, the selection of bulky waste (BW) and processing components (SU 1585019 kl. B 07 V 9/00).

In this system, loading, transporting and unloading mixed household waste in bulk drastically reduces the quality and volume of recoverable secondary material resources (SMR) and leads to significant irretrievable losses of resources and environmental pollution.

Closest to the proposed invention is a system for the collection and disposal of household waste, comprising a receiving device from multiple containers, separate for each type of waste sorting unit with a collection point with the preliminary sorting of mixed and sorted waste, and process equipment, including manual sorting of mixed waste, the line to seal the waste line of crushing, containers for packaging and collection point and park waste crushing and pressing equipment are located inside an enclosed building complex, located on the territory of the serviced residential area. (RU 2261831)

The disadvantage of this system is the connection of a waste collection point with a fleet of equipment for their processing in one complex, the reasons are as follows:
if the complex is put in each yard, the equipment park and the entire complex will be unprofitable for a small amount of waste in one yard, or even three or five;
if the complex is put on a significant number of courtyards, then residents will be far from carrying waste, and this directly contradicts the norm of max 100 m from the house to the waste collection point.

The technical result of the invention is to improve the functional and operational characteristics of the system by constructing elements of a new low-cost infrastructure for the MSW management sector, a multiple cost reduction, achieving almost 100% waste selection, solving environmental and social problems.

### DISCLOSURE OF THE INVENTION

The specified technical result is achieved by the fact that the system for collecting, sorting and processing municipal waste contains means of transport, some waste collection and sorting stations (WCSS) located in the service area, and at least one waste processing workshop (WPW) in the same area.

WCSS is a conditional analogue of the container yard in the existing scheme, and is an indoor closed on the perimeter of the building module is equipped with an extraction window with a counter, a work table for manual sorting of waste, household premises, a cargo truck with a set of containers and bulk waste (BW), instead of the container located in the yard/group homes are offered “inhabited” building module, which created favourable conditions for the manual separation of “several packages”: the organics in one container, dangerous in another, dry mixed in different. WCSS accepts waste already separated by residents in several packages: organic/hazardous/dry mixed/other.

The latter circumstance is explained by the fact that the proposed invention is part of a new concept scheme for recycling MSW, which implements the principle of collecting from the source of education in “several packages”, while the mechanism and motivation for collecting “several packages” are implemented outside the scope of the invention and constitute know-how.

The WPW is equipped with household premises, a fleet of equipment for waste processing, cargo trucks and a tractor, made with the ability to move carts between the WCSS and the WPW.

As the truck is filled at WCSS, a special tractor truck brings the empty truck by bell/graph, and the loaded truck is taken to the WPW, where the waste already divided into fractions is processed—crushed, pressed, packed, and machine batches are brought to the market or for further processing.

Mainly, in the system of collection, sorting and processing of municipal waste, the WCSS is equipped with a glass display case.

Mainly, in the system of collection, sorting and processing of municipal waste, the WPW is designed with the possibility of receiving waste on the principle of “several packages”: organic, hazardous, dry mixed, other.

Mainly, in the system of collection, sorting and processing of municipal waste, the tractor is made with the ability to work from electric accumulators.

### THE DRAWINGS BRIEF DESCRIPTION

FIG. 1 shows a schematic drawing of the service area (urban area) with an indication of the possible locations of the WPW and WCSS.

FIG. 2 shows the plan of the WPW with an indication of the main components.

FIG. 3 shows the plan of the building module of the WCSS.

FIG. 4 shows the front facade of the building module of the WCSS.

### EXAMPLE OF IMPLEMENTATION OF THE INVENTION

As shown in FIG. 1, in the served territory 1 (urban area), waste collection and sorting points 2 are located in accordance with the density of development, similar to container sites in the current schemes.

Waste processing shop 3 is located anywhere in the service area, taking into account sanitary and construction standards.

The structural unit of the city “urban district” is optimally suitable for the proposed system: the limited area of the district allows to optimize logistics, as much as possible reducing the mileage of the tractor with trolley 4; capacity of WPW in tens of tons of MSW per day will allow to ship SMR to consumers in machine batches 5.

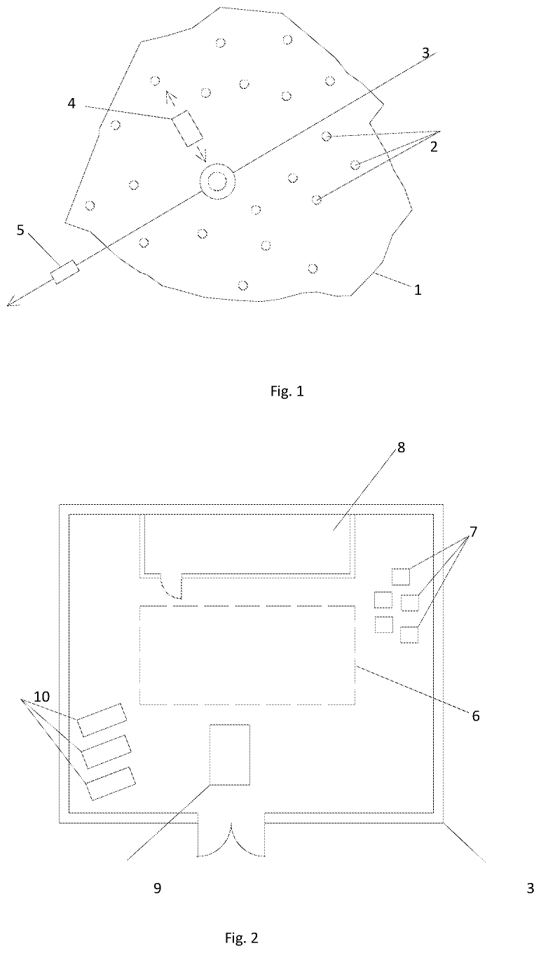

As shown in FIG. 2, the waste processing shop 3 contains a fleet of equipment 6 for waste processing (crushing, pressing, other); a set of containers 7; household premises 8; means of transport: tractor 9, cargo trucks 10.

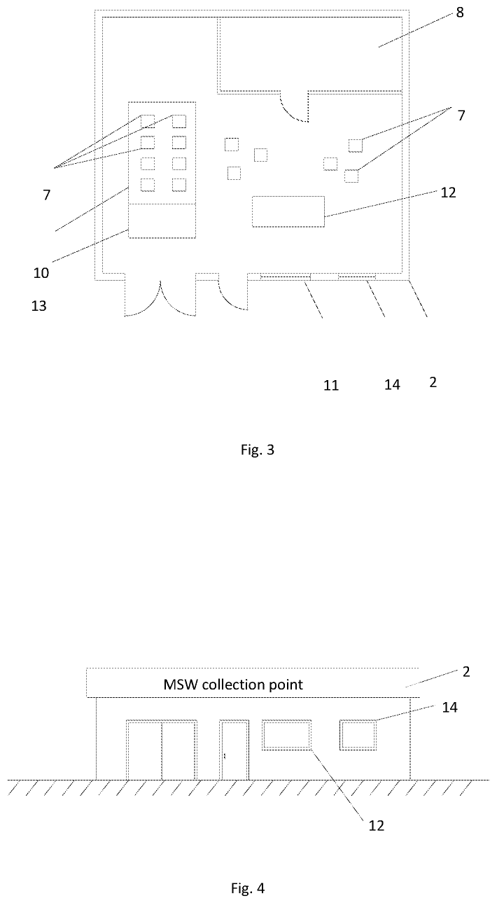

As shown in FIG. 3, WCSS 2 contains a receiving window with a counter 11, a work table for manual sorting of waste 12, a set of containers for separate collection 7, household premises 8, a cargo cart 10 and in it a free space 13 for large-sized waste, a glazed shopping window 14.

FIG. 4 shows the facade of WCSS 2, containing a receiving window 12 and showcase 14.

The system operates as follows.

The system technologies assume the receipt of waste in the receiving window 11 according to the rule in “several packages”: organic/hazardous/dry mixed/other. Bags of organics and hazardous waste are placed by the worker in the appropriate containers, the bag of dry mixed waste is poured on the desktop 12, where the manual division into fractions into an existing set of containers and containers 7. BWs are loaded into free space 13 in the cargo trolley 10. As containers are filled or on schedule, the cargo truck is delivered by a tractor 9 to the WPW-waste processing shop 3. In shop the cart is unloaded and the divided waste is directed on processing: waste paper by kinds on pressing in bales; plastic by kinds on crushing and/or pressing; metals by kinds on pressing/in transport in bulk; glass by kinds and colour on crushing or glass container; ceramics, faience, plaster, etc. for crushing into crumbs; textiles by type for pressing into bales; BWs for preliminary disassembly and/or for special enterprises; electronic and electro technical waste ETW—for special enterprises; mercury-containing waste is crushed on special equipment; organics for compost/biogas/other; waste wood, leather, rubber, etc.—as various fillers and for combustion as an energy source.

WCSS can be equipped with a glass-fronted sales window for the sale of certain types of goods, such as non-freezing, technical and cleaning liquids, etc., delivered by passing flights of cargo carts from the warehouse in the WPW.

WPW can be equipped with an electric tractor, which will give the following advantages: electric transport is eco-friendly and low-noise, which is important in terms of health and comfort of citizens, while it is more economical than transport with internal combustion engines.

The system is able to accept and process industrial waste along with MSW, for example, catering and trade organizations, enterprises that repair household appliances, auto repair shops, woodworking, etc., excluding highly specialized and large-capacity.

The system will allow almost 100% of the district's MSW to be processed within the boundaries of the city district at the lowest possible cost, eliminate so-called “tailings”, optimize logistics, get flows of high-quality SMR, remove environmental and social problems of the industry, and implement the concept of “zero waste”.

1. The system of collection, sorting and recycling of municipal waste containing vehicle, some collection points and waste sorting in the territory served by the district and processing plant wastes in the same area, with collection points and sorting of waste represent an indoor enclosed by the perimeter of the building module is equipped with an extraction window with a counter, a work table for manual sorting of waste, a cargo truck with a set of containers and bulky waste, household rooms, shop recycling provided a fleet of equipment for waste processing, household premises, a cargo trucks and a tractor, made with the possibility of movement of the trolleys between collection points and waste sorting and processing plant waste.

2. The system according to p. 1, characterized in that the point of collection and sorting of waste is equipped with a glass display case.

3. The system according to claim 1, characterized in that the waste collection and sorting point is configured to receive waste “in several packages”: organic, hazardous, dry mixed, other.

4. The system according to p. 1, characterized in that the tractor is made with the possibility of operation from electric accumulators.
